(19) United States
(12) Patent Application Publication
(10) Pub. No.: US 2024/0099379 A1
(43) Pub. Date: Mar. 28, 2024

(54) AEROSOL GENERATING DEVICE

(71) Applicant: NICOVENTURES TRADING LIMITED, London (GB)

(72) Inventors: Anton KORUS, London (GB); Luke WARREN, London (GB); Patrick MOLONEY, London (GB); Matthew HODGSON, London (GB)

(21) Appl. No.: 18/257,794

(22) PCT Filed: Dec. 22, 2021
(86) PCT No.: PCT/EP2021/087336

§ 371 Date: Jun. 15, 2023

(30) Foreign Application Priority Data
Dec. 22, 2020 (GB) 2020393.1

(51) Int. Cl. A24F 40/465; A24F 40/20; A24F 40/70; H05B 6/10; H05B 6/36

(52) U.S. Cl. CPC A24F 40/465; A24F 40/20; A24F 40/70; H05B 6/105; H05B 6/36

(57) ABSTRACT

An aerosol generating device is disclosed and can include comprising a conically shaped inductor coil.

### PRIORITY CLAIM

The present application is a National Phase entry of PCT Application No. PCT/EP2021/087336, filed Dec. 22, 2021, which claims priority from GB Application No. 2020393.1, filed Dec. 22, 2020, each of which is hereby fully incorporated herein by reference.

### TECHNICAL FIELD

The present disclosure relates to an aerosol generating device, an aerosol generating system, a method of fabricating an aerosol generating device and a method of generating an aerosol.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation. It is known to use induction heating systems as heaters to create an aerosol from a suitable medium. An induction heating system generally consists of a magnetic field generating device for generating a varying magnetic field, and a susceptor or heating material which is heatable by penetration with the varying magnetic field to heat the suitable medium.

Many different magnetic field generating devices are known, such as a three dimensional inductor coil. However, there are a variety of constraints, such as the available space, size of device, and power requirements, which places a restriction on the types of magnetic field generating devices. Furthermore, there are a variety of parameters which limit the efficiency of the inductive coupling between the magnetic field generating device and the susceptor or heating material. For example, such parameters include the separation between the magnetic field generating device and the susceptor or heating material, or the relative area sizes and orientations thereof.

It is desired to provide an improved aerosol generating device.

### SUMMARY

According to an aspect there is provided an aerosol generating device comprising a conically shaped inductor coil.

In an embodiment, the aerosol generating device comprises:
a device housing; and/or
a power supply connected to the conically shaped inductor coil, the power supply configured to provide an oscillating current to the conically shaped inductor coil.

In an embodiment, the conically shaped inductor coil has a constant pitch.

In an embodiment, the conically shaped inductor coil has a varying pitch.

In an embodiment, the varying pitch of the conically shaped inductor coil is configured to provide a uniform inductive coupling or constant magnetic flux through a susceptor, optionally wherein the susceptor is a flat susceptor.

In an embodiment, the conically shaped inductor coil comprises a short conical height relative to a conical base width. Optionally, the conically shaped inductor coil has a conical base width W and a conical height H, wherein the ratio W/H is at least 2:1, 3:1, 4:1, 5:1, 6:1, 7:1, 8:1, 9:1, 10:1, 11:1, 12:1, 13:1, 14:1, 15:1, 16:1, 17:1, 18:1, 19:1 or 20:1.

In an embodiment, the conically shaped inductor coil comprises a coil of conducting material comprising a projected shape of: (i) a circular spiral; (ii) a square or rectangular spiral; (iii) a trapezoidal spiral; or (iv) a triangular spiral; and wherein the conically shaped inductor coil comprises a conical base and the projected shape is the shape formed from projecting the coil onto the conical base.

In an embodiment, the projected shape comprises at least one of: (i) a rectilinear side; (ii) a curvilinear side; or (iii) a mixture thereof.

In an embodiment, the conically shaped inductor coil comprises a conical axis and a conical base, wherein the conically shaped inductor coil comprises a cone apex, and the conical axis is a straight line passing through the apex and the center of the conical base.

In an embodiment, the conical axis is perpendicular to the conical base.

In an embodiment, the conical axis is at an angle other than 90 degrees to the conical base.

In an embodiment, the conically shaped inductor coil comprises a coil of conducting material, and the coil of conducting material has a thickness or cross-sectional area which either: (i) varies along the coil; or (ii) is uniform along the coil.

In an embodiment, the conducting material is substantially uniform along the coil.

In an embodiment, the conducting material comprises a composition which varies along the coil.

In an embodiment, the conically shaped inductor coil is formed around a curved plane or three-dimensional surface.

In an embodiment, the curved plane or three-dimensional surface comprises a cylinder.

In an embodiment, the conically shaped inductor coil comprises a conical base, and wherein the conical base is formed around the curved plane or three dimensional surface.

In an embodiment, the aerosol generating device comprises a plurality of conically shaped inductor coils.

In an embodiment, the aerosol generating device comprises a conically shaped bifilar inductor coil, wherein the bifilar coil comprises two or more closely spaced parallel windings.

In an embodiment, the conically shaped inductor coil or the plurality of conically shaped inductor coils are configured to generate a varying magnetic field, optionally wherein the plurality of conically shaped inductor coils are configured to generate a respective varying magnetic field from each one of the conically shaped inductor coils, wherein each of the respective varying magnetic fields are generated independently of each other.

In an embodiment, the device is configured to receive an article for use with a non-combustible aerosol provision device comprising aerosolizable material.

The article may be a substantially flat article. The article may comprise a plurality of discrete portions of aerosolizable material. The article may comprise a substantially flat consumable.

In an embodiment, the aerosol generating device comprises a clamp or restraining device configured to clamp or restrain the article/consumable.

In an embodiment, the clamp or restraining device comprises a cavity wherein the article is inserted in use, the cavity configured such that there is an interference fit between the device and the article.

In an embodiment, the clamp or restraining device is configured to secure the article such that the article conforms to a surface of the conically shaped inductor coil.

In an embodiment, the aerosol generating device comprises one or more susceptors.

In an embodiment, the conically shaped inductor coil or the plurality of conically shaped inductor coils are configured to generate a varying magnetic field and wherein the one or more susceptors are arranged to become heated by the varying magnetic field.

In an embodiment, the plurality of conically shaped inductor coils are independently operable. The plurality of conically shaped inductor coils may be configured to independently heat the one or more susceptors.

In an embodiment, the one or more susceptors are arranged and adapted to heat but not burn aerosolizable material provided in the article/consumable.

In an embodiment, the one or more susceptors are arranged and adapted to generate aerosol from aerosolizable material provided in the article/consumable.

According to another aspect there is provided an aerosol generating device comprising a wrapped planar coil comprising a planar shaped inductor coil wrapped into a cylindrical form, wherein the wrapped planar coil is embedded in a substrate.

In an embodiment, the wrapped planar coil is configured to retain its structure in the substrate.

In an embodiment, the substrate is a resin a plastics material, or other suitable a non-electrically conductive material.

In an embodiment, the inductor coil comprises LITZ® wire or multistrand wire.

In an embodiment, the aerosol generating device comprises a heat not burn aerosol generating device.

In an embodiment, the aerosol generating device comprises a non-combustible aerosol provision device.

According to another aspect there is provided an aerosol generating system comprising: an aerosol generating device as disclosed above and an article for use with a non-combustible aerosol provision device.

In an embodiment, the article for use with a non-combustible aerosol provision device comprises one or more susceptors and wherein the conically shaped inductor coil or the plurality of conically shaped inductor coils are configured to generate a varying magnetic field and wherein the one or more susceptors are arranged to become heated by the varying magnetic field.

According to another aspect there is provided a method of fabricating an aerosol generating device comprising a conically shaped inductor coil, the method comprising: forming a planar inductor coil; and deforming the planar inductor coil out of plane so as to form the conically shaped inductor coil.

According to another aspect there is provided a method of generating an aerosol comprising: providing an aerosol generating device as disclosed above and inserting an article for use with a non-combustible aerosol provision device comprising aerosolizable material into the aerosol generating device.

According to another aspect there is provided an aerosol generating system comprising: an aerosol generating device comprising one or more conically shaped inductor coils; an article for use with a non-combustible aerosol provision device located, in use, within the aerosol generating device; and one or more removable susceptors.

According to another aspect there is provided an aerosol generating system comprising: an aerosol generating device; and an article for use with a non-combustible aerosol provision device located, in use, within the aerosol generating device, wherein the article for use with a non-combustible aerosol provision device comprises one or more conically shaped inductor coils and/or one or more susceptors.

According to another aspect there is provided an aerosol provision device comprising:
a first conically shaped inductor coil;
a second conically shaped inductor coil; and
a susceptor arranged between the first conically shaped inductor coil and the second conically shaped inductor coil.

Optionally, the first conically shaped inductor coil has a conical base width W1 and a conical height H1, wherein the ratio W1/H1 is at least 2:1, 3:1, 4:1, 5:1, 6:1, 7:1, 8:1, 9:1, 10:1, 11:1, 12:1, 13:1, 14:1, 15:1, 16:1, 17:1, 18:1, 19:1 or 20:1.

Optionally, the second conically shaped inductor coil has a conical base width W2 and a conical height H2, wherein the ratio W2/H2 is at least 2:1, 3:1, 4:1, 5:1, 6:1, 7:1, 8:1, 9:1, 10:1, 11:1, 12:1, 13:1, 14:1, 15:1, 16:1, 17:1, 18:1, 19:1 or 20:1.

### BRIEF DESCRIPTION

Various embodiments will now be described, by way of example only, and with reference to the accompanying drawings, in which:

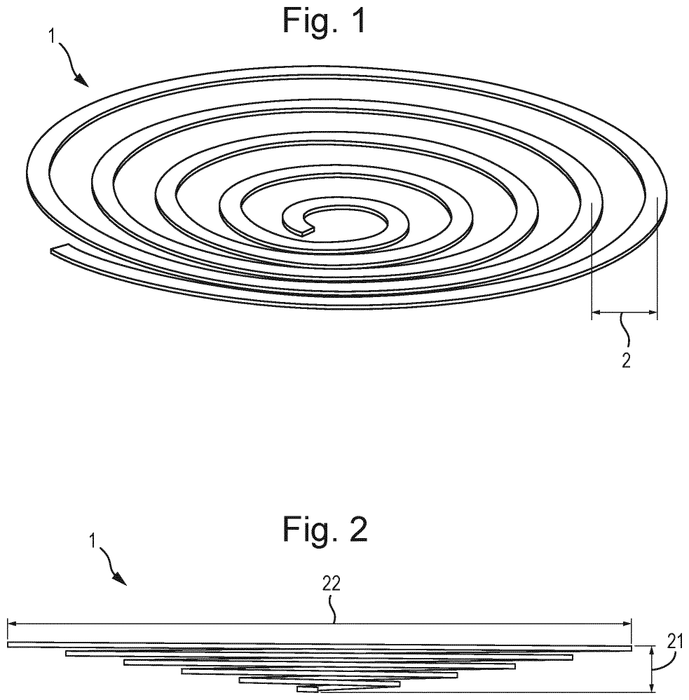

FIG. 1 shows a schematic perspective view of an example of a conically shaped inductor coil for use in an aerosol generating device;

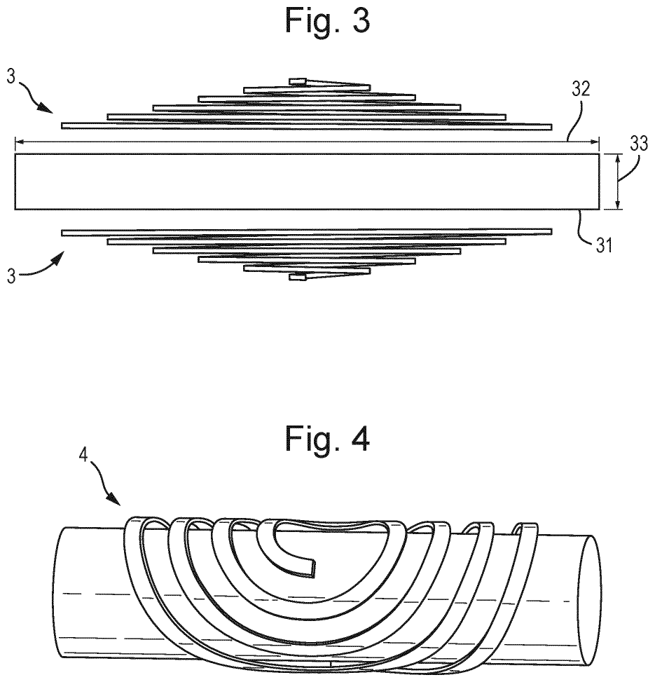

FIG. 2 shows a side-on view of an example of a conically shaped inductor coil for use in an aerosol generating device;

FIG. 3 shows a schematic side-on view of an example of two conically shaped inductor coils positioned relative to a susceptor;

FIG. 4 shows a schematic perspective view of an example of a conically shaped inductor coil arrangement, wherein the conically shaped inductor coil is formed around a cylinder; and

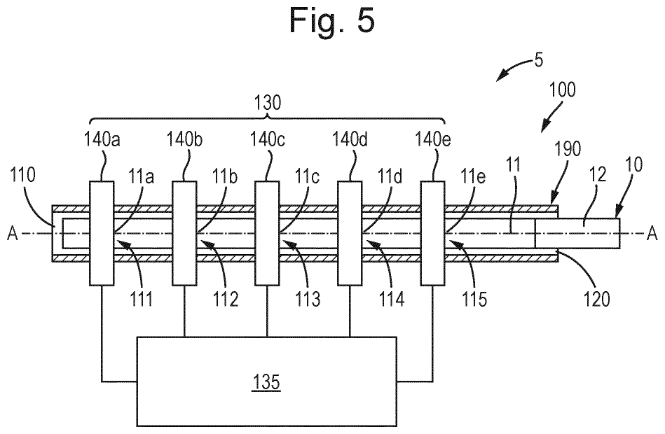

FIG. 5 shows a schematic side view of an example of an electrically-heated aerosol generating system.

### DETAILED DESCRIPTION

As used herein, the term “aerosol generating material” which may also be referred to as “aerosolizable material” includes materials that provide volatilized components upon heating, typically in the form of vapor or an aerosol. “Aerosolizable material” may be a non-tobacco-containing material or a tobacco-containing material.

“Aerosolizable material” may, for example, include one or more of tobacco per se, tobacco derivatives, expanded tobacco, reconstituted tobacco, tobacco extract, homogenised tobacco or tobacco substitutes. The aerosolizable material can be in the form of ground tobacco, cut rag tobacco, extruded tobacco, reconstituted tobacco, reconstituted aerosolizable material, liquid, gel, a solid, an amorphous solid, gelled sheet, powder, beads, granules, or agglomerates, or the like. “Aerosolizable material” also may include other, non-tobacco, products, which, depending on the product, may or may not contain nicotine. “Aerosolizable material” may comprise one or more humectants, such as glycerol or propylene glycol.

A susceptor is material that is heatable by penetration with a varying magnetic field, such as an alternating magnetic field. The heating material may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The heating material may be both electrically-conductive and magnetic, so that the heating material is heatable by both heating mechanisms.

Induction heating is a process in which an electrically-conductive object is heated by penetrating the object with a varying magnetic field. The process is described by Faraday's law of induction and Ohm's law. An induction heater may comprise an electromagnet and a device for passing a varying electrical current, such as an alternating current, through the electromagnet. When the electromagnet and the object to be heated are suitably relatively positioned so that the resultant varying magnetic field produced by the electromagnet penetrates the object, one or more eddy currents are generated inside the object. The object has a resistance to the flow of electrical currents. Therefore, when such eddy currents are generated in the object, their flow against the electrical resistance of the object causes the object to be heated. This process is called Joule, ohmic, or resistive heating.

In one example, the susceptor is in the form of a closed circuit. It has been found that, when the susceptor is in the form of a closed circuit, magnetic coupling between the susceptor and the electromagnet in use is enhanced, which results in greater or improved Joule heating.

Magnetic hysteresis heating is a process in which an object made of a magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example as produced by an electromagnet, penetrates the magnetic material, the orientation of the magnetic dipoles changes with the varying applied magnetic field. Such magnetic dipole reorientation causes heat to be generated in the magnetic material.

When an object is both electrically-conductive and magnetic, penetrating the object with a varying magnetic field can cause both Joule heating and magnetic hysteresis heating in the object. Moreover, the use of magnetic material can strengthen the magnetic field, which can intensify the Joule heating.

In each of the above processes, as heat is generated inside the object itself, rather than by an external heat source by heat conduction, a rapid temperature rise in the object and more uniform heat distribution can be achieved, particularly through selection of suitable object material and geometry, and suitable varying magnetic field magnitude and orientation relative to the object. Moreover, as induction heating and magnetic hysteresis heating do not require a physical connection to be provided between the source of the varying magnetic field and the object, design freedom and control over the heating profile may be greater, and cost may be lower.

Various embodiments will now be described.

Referring to FIGS. 1 and 2, there is shown a schematic of a perspective view and a side-on view, respectively, of an example of a conically shaped induction coil 1 according to an embodiment. The induction coil 1 is for use with an aerosol generating system comprising an aerosol generating device, such as the device 100 shown in FIG. 5 and further described below. In use, a varying (e.g. alternating) electric current is passed through each of the coils so as to create a varying (e.g. alternating) magnetic field that is usable to penetrate a heating element to cause heating of the heating element, as will be described in more detail below.

The induction coil 1 shown in FIGS. 1 and 2 comprises a conical spiral or conical helix of electrically-conductive material, such as copper. As shown in FIG. 2, the conically shaped inductor coil has a conical height 21 and a conical base or base width 22. In embodiments, the conically shaped inductor coil may comprise a shorter conical height relative to a width of the conical base. In other words, the height 21 of the coil may be shorter than the width 22 of the coil.

An inductor coil with no conical height may be referred to as a flat or planar inductor coil, such as having a flat spiral shape. Compared to a flat or planar inductor coil, the conically shaped inductor coils 1,3 as shown and described with reference to FIGS. 1-3 and which relates to various embodiments may facilitate electrical connections to a power supply in a compact manner, wherein the power supply may be configured to provide an oscillating current to the conically shaped inductor coil. It will be appreciated that subjecting an inductor coil to an oscillating current may induce heating within the inductor coil by means of resistive heating. Therefore, the conically shaped inductor coils 1,3 may be configured to better dissipate heat in a controlled manner as compared to a flat inductor coil, as heat dissipated within the plane of the flat inductor coil comprising a plurality of turns will be greater due to the plurality of in-plane turns, whereas the turns of the conically shaped inductor coils do not all reside within the same plane.

In embodiments, the oscillating current may have a frequency of greater than 500 kHz. The oscillating current may have a high frequency of between 1 and 30 MHz, furthermore between 1 and 10 MHz. According to an embodiment the frequency may be between 5 and 7 MHz.

Referring to FIG. 3, there is shown a schematic side-on view of two conically shaped inductor coils 3 positioned relative to a susceptor 31. The susceptor 31 shown in FIG. 3 is has a substantially rectangular cuboid shape. The susceptor 31 may have a thickness 33 substantially smaller than a width 32. The susceptor 31 may be substantially planar. However, in other embodiments the susceptor may have a different shape or configuration as described below.

The two conically shaped inductor coils 3 are shown in FIG. 3 with their respective conical bases facing the susceptor 31, with the conical bases orientated to be parallel to a planar face of the susceptor 31. However, in embodiments, the conical bases of the conically shaped inductor coils 3 may be facing away from the susceptor 31. In embodiments, the conical bases may be orientated so as to not be parallel to a planar face of the susceptor 31, that is, they may be orientated at an angle to the susceptor 31.

Although only a single susceptor 31 is shown in FIG. 3, in embodiments are contemplated wherein a plurality of susceptors may be provided. Similarly, although two conically shaped inductor coils 3 are shown in FIG. 3, other embodiments are contemplated wherein only a single conically shaped inductor coil is provided. According another embodiment more than two conically shaped inductor coils 3 may be provided.

Accordingly, in embodiments, there may be provided one or more conically shaped inductor coils and one or more susceptors, wherein the number of conically shaped inductor coils need not be the same as the number of susceptors. For example, multiple coils and/or susceptors may be provided along the length and/or width of a consumable. In particular, multiple coils and/or susceptors may be provided along the length and/or width of a flat consumable

Furthermore, in embodiments, a first conically shaped inductor coil and a first susceptor may be orientated with respect to each other in a first orientation, and a second conically shaped inductor coil and a second susceptor may be orientated with respect to each other in a second orientation.

In embodiments, the first and second orientations may be the same. Alternatively, the first and second orientations may be different. In yet other embodiments, some orientations between some conically shaped inductor coils and some susceptors may be the same whereas other orientations between other conically shaped inductor coils and other susceptors may be different.

The conically shaped inductor coils 1,3 according to various embodiments as shown in FIGS. 1-3 comprise a short conical height relative to a width of the conical base.

A device (not shown) may be provided for passing a varying electrical current through the conically shaped inductor coils 1,3 such that a varying magnetic field is generated. In embodiments comprising a plurality of conically shaped inductor coils, the device may be configured to be operable to respectively generate a varying magnetic field from each one of the conically shaped inductor coils, wherein each of the varying magnetic fields are generated independently of each other. The varying magnetic fields may induce heating in one or more susceptors. The low conical height-to-width ratio of the conically shaped inductor coils 1,3 may generate a stronger inductive coupling between a conically shaped inductor coil 1,3 and a susceptor 31. For example, this may be because the susceptor 31 may have a shape which conforms to the shape of a conically shaped inductor coil 1,3. In embodiments, the shape of the susceptor 31 conforms to the shape of the conically shaped inductor coil 1,3 because the susceptor 31 comprises a substantially planar surface parallel to and facing the conical base of the conically shaped inductor coil 1,3.

Similarly, in embodiments, the low conical height-to-width ratio of the conically shaped inductor coils 1,3 may also induce a substantially uniform inductive coupling across a relatively large portion of the susceptor 31 or across substantially the entirety of the susceptor 31.

The conically shaped induction coil 1 as shown in FIGS. 1 and 2 has a constant pitch 2, wherein the pitch 2 is the distance separating a point on the coil from an adjacent point after one turn of the coil. However, according to other embodiments, the conically shaped inductor coil may have a varying pitch. In embodiments, the variation of the pitch may be configured such that the conically shaped induction coil may induce a substantially uniform inductive coupling across a large portion of the susceptor 31 or across substantially the entirety of the susceptor 31. In embodiments, the variation of the pitch may be configured such that the conically shaped induction coil may induce a stronger coupling across a first portion of the susceptor compared with a second portion of the susceptor.

The induction coil 1 shown in FIGS. 1 and 2 can be described as having a circular spiral projected shape, wherein a projected shape is the shape formed from projecting the shape of the inductor coil onto the conical base. However, in other embodiments, the conically shaped inductor coil may have a projected shape of a square or rectangular spiral; a trapezoidal spiral; a triangular spiral; or any other two dimensional shape.

The projected shape may be chosen so as to allow positioning of other components within the device in a small and compact manner. In embodiments, the projected shape may have one or more rectilinear sides. In embodiments, the projected shape may have one or more curvilinear sides. In other embodiments, the projected shape may have a mixture or rectilinear and curvilinear sides. In some embodiments, the projected shape of the conically shaped inductor coil conforms with, or substantially conforms with, the shape of a susceptor.

The induction coil 1 shown in FIGS. 1 and 2 can be described as having a conical axis, wherein the conically shaped inductor coil comprises a cone apex, and the conical axis is a straight line passing through the apex and the center of the conical base. The induction coil 1 shown in FIGS. 1 and 2 has a conical axis which is perpendicular to the conical base. In other embodiments, the conical axis may be at an angle other than 90 degrees to the conical base.

Other embodiments are contemplated wherein the induction coil 1 does not have a conical axis as the line about which the coil turns may be curved or otherwise non-linear.

The induction coil 1 shown in FIGS. 1 and 2 has a coil of conducting material with a thickness or cross-sectional area which is uniform along the coil. However, in other embodiments, the thickness or cross-sectional area may vary along the coil. In embodiments, the variation of thickness or cross-sectional area may be configured such that the conically shaped induction coil may induce a substantially uniform inductive coupling across a large portion of the susceptor 31 or across substantially the entirety of the susceptor 31. In embodiments, the variation of thickness or cross-sectional area may be configured such that the conically shaped induction coil may induce a stronger coupling across a first portion of the susceptor compared with a second portion of the susceptor.

In embodiments, the conducting material may comprise a composition which varies along the coil. For example, in some embodiments, a first portion of the conically shaped inductor coil may be formed from a first conducting material and a second portion of the conically shaped inductor coil may be formed from a second conducting material. The material properties of the first and second portions of the conically shaped inductor coil may be different. In embodiments these material properties may comprise electrical properties such as resistivity or conductivity. In embodiments, the variation of the composition of the conducting material along the conically shaped inductor coil may be configured such that the conically shaped induction coil may induce a substantially uniform inductive coupling across a large portion of the susceptor 31 or across substantially the entirety of the susceptor 31. In embodiments, the variation of the composition of the conducting material along the conically shaped inductor coil may be configured such that the conically shaped induction coil may induce a stronger coupling across a first portion of the susceptor compared with a second portion of the susceptor.

In embodiments, the conically shaped inductor coil may be a conically shaped bifilar inductor coil, wherein the bifilar coil comprises two or more closely spaced parallel windings. Providing a conically shaped bifilar inductor coil may increase inductive coupling between the coil and a susceptor, thereby increasing the efficiency of the system. For example, in embodiments, the conically shaped bifilar inductor coil may increase the surface area from which varying magnetic fields may be generated. In embodiments, a conically shaped bifilar inductor coil may also, or alternatively, reduce the self-induction of the inductor coil.

Another embodiment will now be described in more detail with reference to FIG. 4. According to this embodiment an inductor coil 4 is formed around a curved plane or three dimensional surface, such that an initially flat inductor coil may be wrapped around or into a curved plane. For example, in embodiments, the curved plane or three dimensional surface may comprise a cylinder. However, it is to be understood that the inductor coil 4 can be wrapped around other curved planes or three dimensional surfaces. For example, the inductor coil 4 may be folded around the corner of a cuboid shape.

FIG. 4 shows an inductor coil 4 which is a flat or planar inductor coil which is then formed around or wrapped around a cylinder. However, in other embodiments, the inductor coil 4 may be a conically shaped inductor coil 1,3 as discussed above wherein the inductor coil has a non-zero conical height. For example, a conically shaped inductor coil 1,3 may be formed around a curved plane or three dimensional surface by forming the conical base of the conically shaped inductor coil 1,3 around the curved plane or three dimensional surface.

In embodiments, the inductor coil 4 or conically shaped inductor coil 1,3 may be provided on or embedded in a support. Embodiments are contemplated wherein one or more inductor coils 4 and/or one or more conically shaped inductor coils 1,3 may be embedded into or form a mesh with a substrate or support. The substrate, mesh or support may be made from a non-electrically-conductive material, such as a plastics material, so as to electrically-insulate the one or more inductor coils 4 or the one or more conically shaped inductor coils 1,3 from other electronic components, or other inductor coils 4 or conically shaped inductor coils 1,3. In an embodiment, the support or substrate may be made from FR-4, which is a composite material composed of woven fiberglass cloth with an epoxy resin binder that is flame retardant. The one or more inductor coils 4 and/or one or more conically shaped inductor coils 1,3 may be affixed to the support, substrate or mesh in any suitable way. For example, the one or more conically shaped inductor coils 1,3 and/or one or more inductor coils 4 may be formed from printed circuit board (PCB), and may have been formed by printing the electrically-conductive material onto the support during manufacture of the PCB, and then removing (such as by etching) selective portions of the electrically-conductive material so that patterns of the electrically-conductive material in the form the inductor coil 4 or conically shaped inductor coil 1,3 remain on the support, substrate or mesh. In some embodiments, the one or more inductor coils 4 and/or one or more conically shaped inductor coils 1,3 may comprise a thin film or coating of electrically-conductive material on the support.

It should be understood that embodiments are contemplated wherein a mixture of conically shaped inductor coils 1,3 and planar inductor coils 4 may be provided.

Referring again to FIG. 4, the one or more inductor coils 4 may be wrapped into a cylindrical form and embedded in a substrate. In embodiments, the wrapped planar coil 4 may be configured to retain its structure in the substrate. In embodiments, the substrate may comprise a resin.

In some embodiments, the support may be formed other than a layer of a PCB. For example, the layer may be a layer or sheet of material such as resin or adhesive, which may have dried, cured or solidified.

The use of coils formed from thin, printed electrically-conductive material as discussed above obviates the need to use LITZ® wire or multistrand wire. As will be understood by those skilled in the art, LITZ® wire or multistrand wire is comprised of many strands of extremely thin wire gathered in a braid in order to overcome the effects of diminishing skin depth at higher excitation frequencies. Tracks on a PCB may be 25 μm wide. The tracks may have a thickness or depth of 38 μm for 1 oz Cu or around 76 μm for 2 oz Cu and as a result their performance at high frequencies can be comparable to the equivalent cross-sectional area of LITZ® wire or multistrand wire but without problems arising in relation to brittleness, shaping the LITZ® wire or multistrand wire, or connecting it to other components.

Alternatively, in other embodiments, the planar coil(s) and/or conically shaped inductor coil(s) may comprise LITZ® wire or multistrand wire.

Embodiments are also contemplated wherein a first portion of the planar coil(s) and/or conically shaped inductor coil(s) may comprise LITZ® wire or multistrand wire and a second portion of the planar coil(s) and/or conically shaped inductor coil(s) may comprise PCB.

In embodiments, the conically shaped inductor coil as described above may be fabricated by first forming a planar inductor coil and subsequently deforming the planar inductor coil out of plane so as to form the conically shaped inductor coil.

Embodiments are also contemplated wherein the inductor coils as described above may provide for relative movement with respect to the consumable.

Referring to FIG. 5, there is shown a schematic cross-sectional side view of an example of an aerosol generating system 5. The system 5 comprises an aerosol generating device 100 and an article 10 comprising aerosolizable material 11. The aerosolizable material 11 may, for example, be of any of the types of aerosolizable material discussed herein. In this example, the aerosol-generating device 100 is a tobacco heating product (also known in the art as a tobacco heating device or a heat-not-burn device).

In some examples, the aerosolizable material 11 is a non-liquid material. In some examples, the aerosolizable material 11 is a gel. In some examples, the aerosolizable material 11 comprises tobacco. However, in other examples, the aerosolizable material 11 may consist of tobacco, may consist substantially entirely of tobacco, may comprise tobacco and aerosolizable material other than tobacco, may comprise aerosolizable material other than tobacco, or may be free from tobacco. In some examples, the aerosolizable material 11 may comprise a vapor or aerosol forming agent or a humectant, such as glycerol, propylene glycol, triacetin, or diethylene glycol. In some examples, the aerosolizable material 11 comprises reconstituted aerosolizable material, such as reconstituted tobacco.

In some examples, the aerosolizable material 11 is substantially cylindrical with a substantially circular cross section and a longitudinal axis. In other examples, the aerosolizable material 11 may have a different cross-sectional shape and/or not be elongate.

The aerosolizable material 11 of the article 10 may, for example, have an axial length of between 8 mm and 120 mm. For example, the axial length of the aerosolizable material 11 may be greater than 9 mm, or 10 mm, or 15 mm, or 20 mm. For example, the axial length of the aerosolizable material 11 may be less than 100 mm, or 75 mm, or 50 mm, or 40 mm.

In some examples, such as that shown in FIG. 5, the article 10 may comprise a filter arrangement 12 for filtering aerosol or vapor released from the aerosolizable material 11 in use. Alternatively, or additionally, the filter arrangement 12 may be for controlling the pressure drop over a length of the article 10. The filter arrangement 12 may comprise one, or more than one, filter. The filter arrangement 12 could be of any type used in the tobacco industry. For example, the filter may be made of cellulose acetate. In some examples, the filter arrangement 12 is substantially cylindrical with a substantially circular cross section and a longitudinal axis. In other examples, the filter arrangement 12 may have a different cross-sectional shape and/or not be elongate.

In some examples, the filter arrangement 12 abuts a longitudinal end of the aerosolizable material 11. In other examples, the filter arrangement 12 may be spaced from the aerosolizable material 11, such as by a gap and/or by one or more further components of the article 10. In some examples, the filter arrangement 12 may comprise an additive or flavor source (such as an additive- or flavor-containing capsule or thread), which may be held by a body of filtration material or between two bodies of filtration material, for example.

The article 10 may also comprise a wrapper (not shown) that is wrapped around the aerosolizable material 11 and the filter arrangement 12 to retain the filter arrangement 12 relative to the aerosolizable material 11. The wrapper may be wrapped around the aerosolizable material 11 and the filter arrangement 12 so that free ends of the wrapper overlap each other. The wrapper may form part of, or all of, a circumferential outer surface of the article 10. The wrapper could be made of any suitable material, such as paper, card, or reconstituted aerosolizable material (e.g. reconstituted tobacco). The paper may be a tipping paper that is known in the art. The wrapper may also comprise an adhesive (not shown) that adheres overlapped free ends of the wrapper to each other, to help prevent the overlapped free ends from separating. In other examples, the adhesive may be omitted or the wrapper may take a different from to that described. In other examples, the filter arrangement 12 may be retained relative to the aerosolizable material 11 by a connector other than a wrapper, such as an adhesive. In some examples, the filter arrangement 12 may be omitted.

The aerosol generating device 100 comprises a heating zone 110 for receiving at least a portion of the article 10, an outlet 120 through which aerosol is deliverable from the heating zone 110 to a user in use, and heating apparatus 130 for causing heating of the article 10 when the article 10 is at least partially located within the heating zone 110 to thereby generate the aerosol. In some examples, such as that shown in FIG. 5, the aerosol is deliverable from the heating zone 110 to the user through the article 10 itself, rather than through any gap adjacent to the article 10. Nevertheless, in such examples, the aerosol still passes through the outlet 120, albeit while travelling within the article 10.

The device 100 may define at least one air inlet (not shown) that fluidly connects the heating zone 110 with an exterior of the device 100. A user may be able to inhale the volatilized component(s) of the aerosolizable material by drawing the volatilized component(s) from the heating zone 110 via the article 10. As the volatilized component(s) are removed from the heating zone 110 and the article 10, air may be drawn into the heating zone 110 via the air inlet(s) of the device 100.

In this example, the heating zone 110 extends along an axis A-A and is sized and shaped to accommodate only a portion of the article 10. In this example, the axis A-A is a central axis of the heating zone 110. Moreover, in this example, the heating zone 110 is elongate and so the axis A-A is a longitudinal axis A-A of the heating zone 110. The article 10 is insertable at least partially into the heating zone 110 via the outlet 120 and protrudes from the heating zone 110 and through the outlet 120 in use. In other examples, the heating zone 110 may be elongate or non-elongate and dimensioned to receive the whole of the article 10. In some such examples, the device 100 may include a mouthpiece that can be arranged to cover the outlet 120 and through which the aerosol can be drawn from the heating zone 110 and the article 10.

In some examples, the device 100 may comprise a clamp or restraining device (not shown) configured to clamp or restrain the article 10. In other examples, the restraining device comprises a cavity wherein the article 10 is inserted in use, the cavity configured such that there is an interference fit between the device 100 and the article. In some examples the cavity is the heating zone 110.

In this example, when the article 10 is at least partially located within the heating zone 110, different portions 11a-11e of the aerosolizable material 11 are located at different respective locations 110a-110e in the heating zone 110. In this example, these locations 110a-110e are at different respective axial positions along the axis A-A of the heating zone 110. Moreover, in this example, since the heating zone 110 is elongate, the locations 110a-110e can be considered to be at different longitudinally-spaced-apart positions along the length of the heating zone 110. In this example, the article 10 can be considered to comprise five such portions 11a-11e of the aerosolizable material 11 that are located respectively at a first location 110a, a second location 110b, a third location 110c, a fourth location 110d and a fifth location 110e. More specifically, the second location 110b is fluidly located between the first location 110a and the outlet 120, the third location 110c is fluidly located between the second location 110b and the outlet 120, the fourth location 110d is fluidly located between the third location 110c and the outlet 120, and the fifth location is fluidly located between the fourth location 110d and the outlet 120.

The heating apparatus 130 may comprise plural heating units 140a-140e, each of which is able to cause heating of a respective one of the portions 11a-11e of the aerosolizable material 11 to a temperature sufficient to aerosolize a component thereof, when the article 10 is at least partially located within the heating zone 110. The plural heating units 140a-140e may be axially-aligned with each other along the axis A-A. Each of the portions 11a-11e of the aerosolizable material 11 heatable in this way may, for example, have a length in the direction of the axis A-A of between 1 millimeter and 20 millimeters, such as between 2 millimeters and 10 millimeters, between 3 millimeters and 8 millimeters, or between 4 millimeters and 6 millimeters.

The terms “heating units” used herein correspond to the planar and/or conically shaped inductor coil(s) as described in any of the examples of the foregoing as described with reference to FIGS. 1-4.

In some examples, the clamp or restraining device is configured to secure the article 10 such that the article 10 conforms to a surface of at least one of the heating units 140a-140e, for example the conical base of the conically shaped inductor coil.

The heating apparatus 130 of this example comprises five heating units 140a-140e, namely: a first heating unit 140a, a second heating unit 140b, a third heating unit 140c, a fourth heating unit 140d and a fifth heating unit 140e. The heating units 140a-140e are at different respective axial positions along the axis A-A of the heating zone 110. Moreover, in this example, since the heating zone 110 is elongate, the heating units 140a-140e can be considered to be at different longitudinally-spaced-apart positions along the length of the heating zone 110. More specifically, the second heating unit 140b is located between the first heating unit 140a and the outlet 120, the third heating unit 140c is located between the second heating unit 140b and the outlet 120, the fourth heating unit 140d is located between the third heating unit 140c and the outlet 120, and the fifth heating unit 140e is located between the fourth heating unit 140d and the outlet 120. In other examples, the heating apparatus 130 could comprise more than five heating units 140a-140e or fewer than five heating units, such as only four, only three, only two, or only one heating unit. The number of portion(s) of the aerosolizable material 11 that are heatable by the respective heating unit(s) may be correspondingly varied.

The heating units 140a-140e of this example comprise conically shaped inductor coils. The heating apparatus 130 also comprises a controller 135 that is configured to cause operation of the heating units 140a-140e to cause the heating of the respective portions 11a-11e of the aerosolizable material 11 in use. In this example, the controller 135 is configured to cause operation of the heating units 140a-140e independently of each other, so that the respective portions 11a-11e of the aerosolizable material 11 can be heated independently. This may be desirable in order to provide progressive heating of the aerosolizable material 11 in use. Moreover, in examples in which the portions 11a-11e of the aerosolizable material 11 have different respective forms or characteristics, such as different tobacco blends and/or different applied or inherent flavours, the ability to independently heat the portions 11a-11e of the aerosolizable material 11 can enable heating of selected portions 11a-11e of the aerosolizable material 11 at different times during a session of use so as to generate aerosol that has predetermined characteristics that are time-dependent. In some examples, the heating apparatus 130 may nevertheless also be operable in one or more modes in which the controller 135 is configured to cause operation of more than one of the heating units 140a-140e, such as all of the heating units 140a-140e, at the same time during a session of use.

In this example, the heating units 140a-140e comprise respective conically shaped inductor coils that are configured to generate respective varying magnetic fields, such as alternating magnetic fields. As such, the heating apparatus 130 can be considered to comprise a magnetic field generator, and the controller 135 can be considered to be apparatus that is operable to pass a varying electrical current through inductors of the respective heating units 140a-140e.

Moreover, in this example, the device 100 comprises a susceptor 190 that is configured so as to be heatable by penetration with the varying magnetic fields to thereby cause heating of the heating zone 110 and the article 10 therein in use. That is, portions of the susceptor 190 are heatable by penetration with the respective varying magnetic fields to thereby cause heating of the respective portions 11a-11e of the aerosolizable material 11 at the respective locations 110a-110e in the heating zone 110.

The susceptor 190 of this example used herein corresponds to the susceptor 31 as described in any of the examples of the foregoing as described with reference to FIGS. 1-4.

In some examples, the susceptor 190 is made of, or comprises, aluminum. However, in other examples, the susceptor 190 may comprise one or more materials selected from the group consisting of: an electrically-conductive material, a magnetic material, and a magnetic electrically-conductive material. In some examples, the susceptor 190 may comprise a metal or a metal alloy. In some examples, the susceptor 190 may comprise one or more materials selected from the group consisting of: aluminum, gold, iron, nickel, cobalt, conductive carbon, graphite, steel, plain-carbon steel, mild steel, stainless steel, ferritic stainless steel, molybdenum, silicon carbide, copper, and bronze. Other material(s) may be used in other examples.

In some examples, such as those in which the susceptor 190 comprises iron, such as steel (e.g. mild steel or stainless steel) or aluminum, the susceptor 190 may comprise a coating to help avoid corrosion or oxidation of the susceptor 190 in use. Such coating may, for example, comprise nickel plating, gold plating, or a coating of a ceramic or an inert polymer.

In this example, the susceptor 190 is tubular and encircles the heating zone 110. Indeed, in this example, an inner surface of the susceptor 190 partially delimits the heating zone 110. An internal cross-sectional shape of the susceptor 190 may be circular or a different shape, such as elliptical, polygonal, square, rectangular or irregular. In other examples, the susceptor 190 may take a different form, such as a non-tubular structure that still partially encircles the heating zone 110, or a protruding structure, such as a rod, pin or blade, that penetrates the heating zone 110. In some examples, the susceptor 190 may be replaced by plural susceptors, each of which is heatable by penetration with a respective one of the varying magnetic fields to thereby cause heating of a respective one of the portions 11a-11e of the aerosolizable material 11. Each of the plural susceptors may be tubular or take one of the other forms discussed herein for the susceptor 190, for example.

In still further examples, the device 100 may be free from the susceptor 190, and the article 10 may comprise one or more susceptors that are heatable by penetration with the varying magnetic fields to thereby cause heating of the respective portions 11a-11e of the aerosolizable material 11. Each of the one or more susceptors of the article 10 may take any suitable form, such as a structure (e.g. a metallic foil, such as an aluminum foil) wrapped around or otherwise encircling the aerosolizable material 11, a structure located within the aerosolizable material 11, or a group of particles or other elements mixed with the aerosolizable material 11. In examples in which the device 100 is free from the susceptor 190, the susceptor 190 may be replaced by a heat-resistant tube that partially delimits the heating zone 110. Such a heat-resistant tube may, for example, be made from polyether ether ketone (PEEK) or a ceramic material.

In other examples, the conically shaped inductor coils may be arranged such that they are parallel with respect to the susceptor or plural susceptors and the axis A-A in other words they are arranged such that the planar face or side of the coil is parallel to the axis A-A e.g. such that the aerosol generating article is not disposed axially with respect to the coils.

In other examples, the induction coils can be arranged such they heat an entire length or side of the susceptor.

In other examples, the conically shaped inductor coils may be arranged such they form a square or rectangular enclosure around the susceptor 190 or plurality of susceptors 190, such that the entirety of the susceptor or plurality of susceptors are heated.

In this example, the heating apparatus 130 comprises an electrical power source (not shown) and a user interface (not shown) for user-operation of the device. The electrical power source of this example is a rechargeable battery. In other examples, the electrical power source may be other than a rechargeable battery, such as a non-rechargeable battery, a capacitor, a battery-capacitor hybrid, or a connection to a mains electricity supply.

In this example, the controller 135 is electrically connected between the electrical power source and the heating units 140a-140e. In this example, the controller 135 also is electrically connected to the electrical power source. More specifically, in this example, the controller 135 is for controlling the supply of electrical power from the electrical power source to the heating units 140a-140e. In this example, the controller 135 comprises an integrated circuit (IC), such as an IC on a printed circuit board (PCB). In other examples, the controller 135 may take a different form. The controller 135 is operated in this example by user-operation of the user interface. The user interface may comprise a push-button, a toggle switch, a dial, a touchscreen, or the like. In other examples, the user interface may be remote and connected to the rest of the aerosol provision device 100 wirelessly, such as via Bluetooth.

In this example, operation of the user interface by a user causes the controller 135 to cause an alternating electrical current to pass through the conically shaped inductor coil of at least one of the respective heating units 140a-140e. This causes the inductor to generate an alternating magnetic field. The inductor and the susceptor 190 are suitably relatively positioned so that the varying magnetic field produced by the inductor penetrates the susceptor 190. When the susceptor 190 is electrically-conductive, this penetration causes the generation of one or more eddy currents in the susceptor 190. The flow of eddy currents in the susceptor 190 against the electrical resistance of the susceptor 190 causes the susceptor 190 to be heated by Joule heating. When the susceptor 190 is magnetic, the orientation of magnetic dipoles in the susceptor 190 changes with the changing applied magnetic field, which causes heat to be generated in the susceptor 190.

The device 100 may comprise a temperature sensor (not shown) for sensing a temperature of the heating chamber 110, the susceptor 190 or the article 10. The temperature sensor may be communicatively connected to the controller 135, so that the controller 135 is able to monitor the temperature of the heating chamber 110, the susceptor 190 or the article 10, respectively, on the basis of information output by the temperature sensor. In other examples, the temperature may be sensed and monitored by measuring electrical characteristics of the system, e.g., the change in current within the heating units 140a-140e. On the basis of one or more signals received from the temperature sensor, the controller 135 may cause a characteristic of the varying or alternating electrical current to be adjusted as necessary, in order to ensure that the temperature of the heating chamber 110, the susceptor 190 or the article 10, respectively, remains within a predetermined temperature range. The characteristic may be, for example, amplitude or frequency or duty cycle. Within the predetermined temperature range, in use the aerosolizable material 11 within the article 10 located in the heating chamber 110 is heated sufficiently to volatilize at least one component of the aerosolizable material 11 without combusting the aerosolizable material 11. Accordingly, the controller 135, and the device 100 as a whole, is arranged to heat the aerosolizable material 11 to volatilize the at least one component of the aerosolizable material 11 without combusting the aerosolizable material 11. The temperature range may be between about 50° C. and about 350° C., such as between about 100° C. and about 300° C., or between about 150° C. and about 280° C. In other examples, the temperature range may be other than one of these ranges. In some examples, the upper limit of the temperature range could be greater than 350° C. In some examples, the temperature sensor may be omitted.

In the foregoing examples, the size or extent of the varying magnetic fields as measured in the direction of the axis A-A is relatively small, so that the portions of the susceptor 190 that are penetrated by the varying magnetic fields in use are correspondingly small. Accordingly, it may be desirable for the susceptor 190 to have a thermal conductivity that is sufficient to increase the proportion of the susceptor 190 that is heated by thermal conduction as a result of the penetration by the varying magnetic fields, so as to correspondingly increase the proportion of the aerosolizable material 11 that is heated by operation of each of the heating units 140a-140e. It has been found that it is desirable to provide the susceptor 190 with a thermal conductivity of at least 10 W/m/K, optionally at least 50 W/m/K, and further optionally at least 100 W/m/K. In this example, the susceptor 190 is made of aluminum and has a thermal conductivity of over 200 W/m/K, such as between 200 and 250 W/m/K, for example approximately 205 W/m/K or 237 W/m/K. As noted above, each of the portions 11a-11e of the aerosolizable material 11 may, for example, have a length in the direction of the axis A-A of between 1 millimeter and 20 millimeters, such as between 2 millimeters and 10 millimeters, between 3 millimeters and 8 millimeters, or between 4 millimeters and 6 millimeters.

It will be understood that, for a given duration of heating session, the greater the number of heating units and associated portions of the aerosolizable material 11 there are, the greater the opportunity to generate aerosol from “fresh” or unspent portions of the aerosolizable material 11 extending along a given axial length. Alternatively, for a given duration of heating each portion of the aerosolizable material 11, the greater the number of heating units and associated portions of the aerosolizable material 11 there are, the longer the heating session may be. It should be appreciated that the duration for which an individual heating unit may be activated can be adjusted (e.g. shortened) to adjust (e.g. reduce) the overall heating session, and at the same time the power supplied to the heating element may be adjusted (e.g. increased) to reach the operational temperature more quickly. There may be a balance that is struck between the number of heating units (which may dictate the number of “fresh puffs”), the overall session length, and the achievable power supply (which may be dictated by the characteristics of the power source).

In some embodiments, the aerosol generating system is an electronic cigarette, also known as a vaping device or electronic nicotine delivery system (END), although it is noted that the presence of nicotine in the aerosol generating material is not a requirement.

In some embodiments, the aerosol generating system is a tobacco heating system, also known as a heat-not-burn system.

In some embodiments, the aerosol generating system is a hybrid system to generate aerosol using a combination of aerosol generating materials, one or a plurality of which may be heated. Each of the aerosol generating materials may be, for example, in the form of a solid, liquid or gel and may or may not contain nicotine. In some embodiments, the hybrid system comprises a liquid or gel aerosol generating material and a solid aerosol generating material. The solid aerosol generating material may comprise, for example, tobacco or a non-tobacco product.

Typically, the aerosol generating system may comprise an aerosol generating device and an article for use with the aerosol generating device. However, it is envisaged that articles which themselves comprise a means for powering an aerosol generating component may themselves form the aerosol generating system.

In some embodiments, the aerosol generating device may comprise a power source and a controller. The power source may, for example, be an electric power source.

In some embodiments, the article for use with the aerosol generating device may comprise an aerosol generating material, an aerosol generating component, an aerosol generating area, a mouthpiece, and/or an area for receiving aerosol generating material.

In some embodiments, the aerosol generating component is a heater capable of interacting with the aerosol generating material so as to release one or more volatiles from the aerosol generating material to form an aerosol.

In some embodiments, the substance to be delivered may be an aerosol generating material. Aerosol generating material, which also may be referred to herein as aerosol generating material, is material that is capable of generating aerosol, for example when heated, irradiated or energized in any other way.

Aerosol generating material may, for example, be in the form of a solid, liquid or gel which may or may not contain nicotine and/or flavorants. In some embodiments, the article for use with the aerosol generating device may comprise aerosol generating material or an area for receiving aerosol generating material. In some embodiments, the article for use with the aerosol generating device may comprise a mouthpiece. The area for receiving aerosol generating material may be a storage area for storing aerosol generating material. For example, the storage area may be a reservoir. In some embodiments, the area for receiving aerosol generating material may be separate from, or combined with, an aerosol generating area.

In some embodiments, the article 10 is a consumable article or an article for use with a non-combustible aerosol provision device. Once all, or substantially all, of the volatilizable component(s) of the aerosolizable material 11 in the article 10 has/have been spent, the user may remove the article 10 from the heating zone 110 of the aerosol generating device 100 and dispose of the article 10. The user may subsequently re-use the aerosol generating device 100 with another of the articles 10. However, in other respective embodiments, the article 10 may be non-consumable relative to the heating apparatus 130. That is, heating apparatus 130 and the article 2 may be disposed of together once the volatilizable component(s) of the aerosolizable material 11 has/have been spent.

In some embodiments, the article 10 is sold, supplied or otherwise provided separately from the aerosol generating device 100 with which the article 10 is usable. However, in some embodiments, the aerosol generating device 100 and one or more of the articles 10 may be provided together as a system, such as a kit or an assembly, possibly with additional components, such as cleaning utensils.

In some embodiments, the aerosol generating device further comprises a flux concentrator, such as a magnetically permeable core. In some embodiments, the inductor coil as described above may be wound or wrapped around a portion of the flux concentrator. In other embodiments, the inductor coil may be adjacent to or embedded in the flux concentrator.

For example, the flux concentrator or magnetically permeable core concentrates the magnetic flux produced by an inductor coil in use and makes a more powerful magnetic field. Furthermore, the magnetically permeable core helps to direct the magnetic flux to its intended target. The intended target in the embodiments discussed above is one or more susceptors. In some embodiments, the coil 140 may be wound around only a portion (i.e. not all) of the flux concentrator. In embodiments, the magnetically permeable core can have high magnetic permeability and low electrical conductivity. The latter helps prevent the generation of eddy currents in the magnetically permeable core in use, which helps to prevent the magnetically permeable core becoming heated in use.

The magnetically permeable core may comprise, or may be composed of, ferrite. The ferrite may, for example, contain iron oxide combined with nickel and/or zinc and/or manganese. The ferrite may have a low coercivity and be considered a “soft ferrite”, or have a high coercivity and be considered a “hard ferrite”. Example usable soft ferrites are manganese-zinc ferrite, with the formula MnaZn(i-a) Fe₂O₄, and nickel-zinc ferrite, with the formula NiaZn(i-a) Fe₂O₄. However, in respective variations to these embodiments, the magnetically permeable core may be made of a different material or materials. For example, in some embodiments, the magnetically permeable core may comprise plural layers of electrically-conductive material that are isolated from one another by non-electrically-conductive material. The magnetically permeable core may have dozens, or even hundreds, of layers of electrically-conductive material that are isolated from one another by non-electrically-conductive material. In embodiments comprising a plurality of induction coils, there may be provided a plurality of flux concentrators or magnetically permeable cores, wherein each one of the plurality of flux concentrators or magnetically permeable cores corresponds to a respective induction coil of the plurality of induction coils.

The aerosol generating device, aerosol generating system and the inductor coil according to various embodiments find particular utility when generating aerosol from a substantially flat consumable.

The substantially flat consumable may be provided in either an array or a circular format. Other arrangements are also contemplated.

In some embodiments e.g. wherein the substantially flat consumable is provided in the form of an array, multiple heating regions may be provided. For example, according to an embodiment one heating region may be provided per portion, pixel or portion of the consumable.

In other embodiments, the substantially flat consumable may be rotated such that a segment of the consumable is heated by a similar shaped heater. According to this embodiment a single heating region may be provided.

In particular, the inductor coil according to various embodiments may be provided as part of a non-combustible aerosol provision device which is arranged to heat-not-burn a consumable as part of a non-combustible aerosol provision system. In particular, the consumable may comprise a plurality of discrete portions of aerosol-generating material.

The consumable may comprise a support on which the aerosol-generating material is provided. The support functions as a support on which the aerosol-generating material forms, easing manufacture. The support may provide tensile strength to the aerosol-generating material, easing handling. In some cases, the plurality of discrete portions of aerosol-generating material are deposited on such a support. In some cases, the plurality of discrete portions of amorphous material is deposited on such a support. In some cases, the discrete portions of aerosol-generating material are deposited on such a support such that each discrete portion may be heated and aerosolized separately. In an exemplary embodiment the consumable comprises a plurality of discrete portions of aerosol-generating material comprising an amorphous solid, the discrete portions provided on a support and each of the discrete portions comprising less than 15 mg of water.

Suitably, the discrete portions of aerosol-generating material are provided on the support such that each discrete portion may be heated and aerosolized separately. It has been found that a consumable having such a conformation allows a consistent aerosol to be delivered to the user with each puff.

In some cases, the support may be formed from materials selected from metal foil, paper, carbon paper, greaseproof paper, ceramic, carbon allotropes such as graphite and graphene, plastic, cardboard, wood or combinations thereof. In some cases, the support may comprise or consist of a tobacco material, such as a sheet of reconstituted tobacco. In some cases, the support may be formed from materials selected from metal foil, paper, cardboard, wood or combinations thereof. In some cases, the support itself be a laminate structure comprising layers of materials selected from the preceding lists. In some cases, the support may also function as a flavorant carrier. For example, the support may be impregnated with a flavorant or with tobacco extract.

In some cases, the support may be non-magnetic.

In some cases, the support may be magnetic. This functionality may be used to fasten the support to the assembly in use, or may be used to generate particular amorphous solid shapes. In some cases, the aerosol-generating material may comprise one or more magnets which can be used to fasten the material to an induction heater in use.

In some cases, the support may be substantially or wholly impermeable to gas and/or aerosol. This prevents aerosol or gas passage through the support layer, thereby controlling the flow and ensuring it is delivered to the user. This can also be used to prevent condensation or other deposition of the gas/aerosol in use on, for example, the surface of a heater provided in an aerosol generating assembly. Thus, consumption efficiency and hygiene can be improved in some cases.

In some cases, the surface of the support that abuts the aerosol-generating material may be porous. For example, in one case, the support comprises paper. It has been found that a porous support such as paper is particularly suitable for the present disclosure; the porous (e.g. paper) layer abuts the aerosol-generating material and forms a strong bond. The aerosol-generating material is formed by drying a gel and, without being limited by theory, it is thought that the slurry from which the gel is formed partially impregnates the porous support (e.g. paper) so that when the gel sets and forms cross-links, the support is partially bound into the gel. his provides a strong binding between the gel and the support (and between the dried gel and the support).

In one particular case, the support may be a paper-backed foil; the paper layer abuts the aerosol-generating material and the properties discussed in the previous paragraphs are afforded by this abutment. The foil backing is substantially impermeable, providing control of the aerosol flow path. A metal foil backing may also serve to conduct heat to the aerosol-generating material.

In another case, the foil layer of the paper-backed foil abuts the aerosol-generating material. The foil is substantially impermeable, thereby preventing water provided in the aerosol-generating material to be absorbed into the paper which could weaken its structural integrity.

In some cases, the support is formed from or comprises metal foil, such as aluminum foil. A metallic support may allow for better conduction of thermal energy to the amorphous solid. Additionally, or alternatively, a metal foil may function as a susceptor in an induction heating system. In particular embodiments, the support comprises a metal foil layer and a support layer, such as cardboard. In these embodiments, the metal foil layer may have a thickness of less than 20 μm, such as from about 1 μm to about 10 μm, suitably about 5 μm.

In some cases, the support may have a thickness of between about 0.010 mm and about 2.0 mm, suitably from about 0.015 mm, 0.02 mm, 0.05 mm or 0.1 mm to about 1.5 mm, 1.0 mm, or 0.5 mm.

Suitably, the aerosol-generating material comprises an amorphous solid, wherein less than about 15 mg of water is aerosolized during each puff, when the aerosol-generating material is heated to a temperature of at least 120° C. in an aerosol provision device. The specific features discussed above in relation to the aerosol-generating material when present in the consumable apply equally to the aerosol-generating material when taken in isolation.

A further embodiment is contemplated wherein the conical coil may be used as a 3D form e.g. when supported by an epoxy potting or polymer overmold into which a corresponding preformed 3D shape could be fitted.

A flat or substantially flat susceptor may be loaded into a device and then a secondary operation (e.g. a lid closing or activating a clamping component) may load the flat susceptor and reshape the susceptor to the conical form (either onto the convex or concave face). Other embodiments are contemplated wherein a susceptor having a different shape and/or configuration may be provided and wherein a secondary operation (e.g. a lid closing or activating a clamping component) may load the susceptor and reshape the susceptor to the conical form (either onto the convex or concave face).

It will be understood that the present embodiment is beneficial since the coil to susceptor distance is important for coupling efficiency especially for thin, low permeability susceptors.

Accordingly, having a uniform distance between the coil and the susceptor is beneficial.

Furthermore, having distortions in the flat susceptor shape may likewise affect the coupling efficiency or the system's resonant frequency—having a small level of preload on the susceptor is one way to ensure better shape uniformity.

The present embodiment is particularly beneficial where the susceptor may be part of the consumable—meaning each time the consumable is loaded a different level of shape variability is introduced.

According to another embodiment a spiral like structure is contemplated wherein multilevel layers are used to implement the inductive nature of the coils.

According to this embodiment, control of the PCB tracking is key to control of inductance and coupling. The coils may be staggered and may comprise tesla coils (bifilar).

It will be understood that all susceptor material will be metallic in nature. If the permeability of the metal is high, then like Iron the warming mechanism is via magnetic domains aligning and being influenced by the AC field which is sometimes referred to as hysteresis warming, where the physical movement of the atoms create heat in addition to the eddy current warming when the permeability of the metal is low such as aluminum foil. The aluminum foils are very thin and do not obey the classic physics of skin depth warming.

It should be understood that reference to LITZ® relates to multistrand wire and the term multistrand may be substituted for the term LITZ®.

Copper is used on PCB and skin depth is an important factor and 4 oz copper is used to operate with at least one skin depth from 1 MHz on PCB coils. One skin depth at 1 MHz is 63 μm of copper. Multistrand wire has a different operating frequency range and may be as low as 300 kHz in some cases. With regards the frequencies ranges discussed above, embodiments are contemplated wherein the frequency range for PCB may be in the range 700 kHz to 5 MHz. With regards multistrand wire or LITZ® the frequency range may be 200 kHz to 2 MHz.

According to another embodiment a bonded multistrand version of the conical inductor is contemplated which holds the coil in that specific shape.

While the above-described embodiments have in some respects focused on some specific example aerosol generating systems, it will be appreciated the same principles can be applied for aerosol generating systems using other technologies. That is to say, the specific manner in which various aspects of the aerosol generating provision system function are not directly relevant to the principles underlying the examples described herein.

In order to address various issues and advance the art, this disclosure shows by way of illustration various embodiments in which the claimed invention(s) may be practised. The advantages and features of the disclosure are of a representative sample of embodiments only, and are not exhaustive and/or exclusive. They are presented only to assist in understanding and to teach the claimed invention(s). It is to be understood that advantages, embodiments, examples, functions, features, structures, and/or other aspects of the disclosure are not to be considered limitations on the disclosure as defined by the claims or limitations on equivalents to the claims, and that other embodiments may be utilized and modifications may be made without departing from the scope of the claims. Various embodiments may suitably comprise, consist of, or consist essentially of, various combinations of the disclosed elements, components, features, parts, steps, means, etc. other than those specifically described herein, and it will thus be appreciated that features of the dependent claims may be combined with features of the independent claims in combinations other than those explicitly set out in the claims. The disclosure may include other inventions not presently claimed, but which may be claimed in future.

1. An aerosol generating device comprising a conically shaped inductor coil.

2. An aerosol generating device as claimed in claim 1, wherein the device comprises:
a device housing; and/or
a power supply connected to the conically shaped inductor coil, the power supply being configured to provide a oscillating current to the conically shaped inductor coil.

3. An aerosol generating device as claimed in claim 1 or 2, wherein the conically shaped inductor coil has a constant pitch.

4. An aerosol generating device as claimed in claim 1 or 2, wherein the conically shaped inductor coil has a varying pitch.

5. An aerosol generating device as claimed in claim 4, wherein the varying pitch of the conically shaped inductor coil is configured to provide a uniform inductive coupling or constant magnetic flux through a susceptor, optionally wherein the susceptor is a flat susceptor.

6. An aerosol generating device as claimed in any preceding claim, wherein the conically shaped inductor coil has a shorter conical height relative to a conical base width.

7. An aerosol generating device as claimed in claim 6, wherein the conically shaped inductor coil has a conical base width W and a conical height H, wherein the ratio W/H is at least 2:1, 3:1, 4:1, 5:1, 6:1, 7:1, 8:1, 9:1, 10:1, 11:1, 12:1, 13:1, 14:1, 15:1, 16:1, 17:1, 18:1, 19:1 or 20:1.

8. An aerosol generating device as claimed in any preceding claim, wherein the conically shaped inductor coil comprises a coil of conducting material comprising a projected shape of: (i) a circular spiral; (ii) a square or rectangular spiral; (iii) a trapezoidal spiral; or (iv) a triangular spiral; and wherein the conically shaped inductor coil comprises a conical base and the projected shape is the shape formed from projecting the coil onto the conical base.

9. An aerosol generating device as claimed in claim 8, wherein the projected shape comprises at least one of: (i) a rectilinear side; (ii) a curvilinear side; or (iii) a mixture thereof.

10. An aerosol generating device as claimed in any preceding claim, wherein the conically shaped inductor coil has a conical axis and a conical base, wherein the conically shaped inductor coil has a cone apex, and the conical axis is in a straight line passing through the apex and the centre of the conical base.

11. An aerosol generating device as claimed in claim 10, wherein the conical axis is perpendicular to the conical base.

12. An aerosol generating device as claimed in claim 10, wherein the conical axis is at an angle other than 90° to the conical base.

13. An aerosol generating device as claimed in any preceding claim, wherein the conically shaped inductor coil comprises a coil of conducting material, and the coil of conducting material has a thickness or cross-sectional area which either: (i) varies along the coil; or (ii) is uniform along the coil.

14. An aerosol generating device as claimed in claim 13, wherein the conducting material is substantially uniform along the coil.

15. An aerosol generating device as claimed in claim 13, wherein the conducting material comprises a composition which varies along the coil.

16. An aerosol generating device as claimed in any preceding claim, wherein the conically shaped inductor coil is formed around a curved plane or three dimensional surface.

17. An aerosol generating device as claimed in claim 16, wherein the curved plane or three dimensional surface comprises a cylinder.

18. An aerosol generating device as claimed in claim 16 or 17, wherein the conically shaped inductor coil comprises a conical base, and wherein the conical base is formed around the curved plane or three dimensional surface.

19. An aerosol generating device as claimed in any preceding claim, wherein the aerosol generating device comprises a plurality of conically shaped inductor coils.

20. An aerosol generating device as claimed in any preceding claim, wherein the aerosol generating device comprises a conically shaped bifilar inductor coil, wherein the bifilar coil comprises two or more closely spaced parallel windings.

21. An aerosol generating device as claimed in any preceding claim, wherein the conically shaped inductor coil or the plurality of conically shaped inductor coils are configured to generate a varying magnetic field, optionally wherein the plurality of conically shaped inductor coils are configured to generate a respective varying magnetic field from each one of the conically shaped inductor coils, wherein each of the respective varying magnetic fields are generated independently of each other.

22. An aerosol generating device as claimed in any preceding claim, wherein the device is configured to receive an article for use with a non-combustible aerosol provision device comprising aerosolisable material.

23. An aerosol generating device as claimed in claim 22, wherein the aerosol generating device comprises a clamp or restraining device configured to clamp or restrain the article.

24. An aerosol generating device as claimed in claim 23, wherein the clamp or restraining device comprises a cavity into which the article is inserted in use, wherein the cavity is configured such that there is an interference fit between the device and the article.

25. An aerosol generating device as claimed in claim 23 or 24, wherein the clamp or restraining device is configured to secure the article such that the article conforms to a surface of the conically shaped inductor coil.

26. An aerosol generating device as claimed in any preceding claim, wherein the aerosol generating device comprises one or more susceptors.

27. An aerosol generating device as claimed in claim 26, wherein the conically shaped inductor coil or the plurality of conically shaped inductor coils are configured to generate a varying magnetic field and wherein the one or more susceptors are arranged to become heated by the varying magnetic field.

28. An aerosol generating device as claimed in claim 27, wherein the one or more susceptors are arranged and adapted to heat but not burn aerosolisable material provided in an article for use with a non-combustible aerosol provision device.

29. An aerosol generating device as claimed in claim 27 or 28, wherein the one or more susceptors are arranged and adapted to generate aerosol from aerosolisable material provided in the article.

30. An aerosol generating device comprising a wrapped planar coil comprising a planar shaped inductor coil wrapped into a cylindrical form optionally wherein the wrapped planar coil is embedded in a substrate.

31. An aerosol generating device as claimed in claim 30, wherein the wrapped planar coil is configured to retain its structure in the substrate.

32. An aerosol generating device as claimed in claim 30 or 31, wherein the substrate is a resin.

33. An aerosol generating device as claimed in any of claim 30, 31 or 32, wherein the inductor coil comprises LITZ® wire or multistrand wire.

34. An aerosol generating device as claimed in any preceding claim, wherein the aerosol generating device comprises a heat not burn aerosol generating device.

35. An aerosol generating device as claimed in any preceding claim, wherein the aerosol generating device comprises a non-combustible aerosol provision device.

36. An aerosol generating system comprising:
an aerosol generating device as claimed in any preceding claim; and
an article for use with a non-combustible aerosol provision device.

37. An aerosol generating system as claimed in claim 36, wherein the article for use with a non-combustible aerosol provision device comprises one or more susceptors, and wherein the conically shaped inductor coil or the plurality of conically shaped inductor coils are configured to generate a varying magnetic field and wherein the one or more susceptors are arranged to become heated by the varying magnetic field.

38. A method of fabricating an aerosol generating device comprising a conically shaped inductor coil, the method comprising:
forming a planar inductor coil; and
deforming the planar inductor coil out of plane so as to form the conically shaped inductor coil.

39. A method of generating an aerosol comprising:
providing an aerosol generating device as claimed in any of claims 1-35; and
inserting an article for use with a non-combustible aerosol provision device comprising aerosolisable material into the aerosol generating device.

40. An aerosol generating system comprising:
an aerosol generating device comprising one or more conically shaped inductor coils;
an article for use with a non-combustible aerosol provision device located, in use, within the aerosol generating device; and
one or more removable susceptors.

41. An aerosol generating system comprising:
an aerosol generating device; and
an article for use with a non-combustible aerosol provision device located, in use, within the aerosol generating device, wherein the article for use with a non-combustible aerosol provision device comprises one or more conically shaped inductor coils and/or one or more susceptors.

42. An aerosol provision device comprising:
a first conically shaped inductor coil;
a second conically shaped inductor coil; and
a susceptor arranged between the first conically shaped inductor coil and the second conically shaped inductor coil.

43. An aerosol provision device as claimed in claim 42, wherein the first conically shaped inductor coil has a conical base width W1 and a conical height H1, wherein the ratio W1/H1 is at least 2:1, 3:1, 4:1, 5:1, 6:1, 7:1, 8:1, 9:1, 10:1, 11:1, 12:1, 13:1, 14:1, 15:1, 16:1, 17:1, 18:1, 19:1 or 20:1.

44. An aerosol provision device as claimed in claim 42 or 43, wherein the second conically shaped inductor coil has a conical base width W2 and a conical height H2, wherein the ratio W2/H2 is at least 2:1, 3:1, 4:1, 5:1, 6:1, 7:1, 8:1, 9:1, 10:1, 11:1, 12:1, 13:1, 14:1, 15:1, 16:1, 17:1, 18:1, 19:1 or 20:1.
